(19) United States
(12) Patent Application Publication
(10) Pub. No.: US 2026/0199794 A1
(43) Pub. Date: Jul. 16, 2026

(54) GAME INTEGRATION OF THIRD-PARTY FOR MANAGEMENT OF ASSET EXCHANGES

(71) Applicant: Wells Fargo Bank, N.A., San Francisco, CA (US)

(72) Inventors: Spencer McCoy Alexander, Charlotte, NC (US); Peter Ho, Walnut Creek, CA (US); Matthew Tyler Hord, Stanley, NC (US); Andrea Renee Leighton, San Francisco, CA (US); Lucy Xi Zhang, Walnut Creek, CA (US)

(21) Appl. No.: 19/020,914

(22) Filed: Jan. 14, 2025

(51) Int. Cl. A63F 13/792; A63F 13/65; G06Q 30/018; G06Q 30/0601

(52) U.S. Cl. CPC A63F 13/792; A63F 13/65; G06Q 30/0601; G06Q 30/0185

(57) ABSTRACT

Methods, systems, and computer programs are presented to integrate a third-party entity in a game to facilitate exchange of assets within the game. One method includes operations for adding an asset manager (AM) to a game environment and configuring the AM in the game environment to facilitate asset transactions between players. The method further includes detecting, by the AM, a request for an exchange of a real-world (RW) asset owned by a first player for an in-game (IG) asset owned by a second player, and transferring, by an AM server, the RW asset from a RW account of the first player to an account of the AM. The AM detects an in-game transfer of the IG asset from the second player to the first player, and the AM server transfers the RW asset to a real-world account of the second player. Further, a notification is that the exchange was successful.

### TECHNICAL FIELD

The subject matter disclosed herein generally relates to methods, systems, and machine-readable storage media for managing player interactions in a game.

### BACKGROUND

In the world of video games, in-game transactions present significant challenges related to player authentication and the secure exchange of digital assets. The absence of a reliable system for verifying player identities and asset legitimacy increases the risk of fraud and unauthorized transfers.

When a player wants to trade, the player may have concerns about the authenticity of the items being exchanged. Current systems do not adequately address the verification of player inventory or the legitimacy of assets, which can result in disputes and loss of trust among users. Additionally, the potential for corrupted transactions poses a risk to the integrity of the in-game economy.

The need for a seamless user experience is important, yet some current transaction processes may require players to navigate external marketplaces, detracting from the immersive gaming experience. The challenge of ensuring immediate access to purchased items while maintaining secure and verified transactions remains unresolved.

### BRIEF DESCRIPTION OF THE DRAWINGS

Various appended drawings illustrate examples of the present disclosure and cannot be considered limiting its scope.

FIG. 1 is a simplified schematic diagram of a computer architecture for implementing the examples described herein.

FIG. 2 illustrates a distributed data architecture according to some examples.

FIG. 3 is a flowchart of a method for the integration of a third party in a game, according to some examples.

FIG. 4 is a flowchart of a method for implementing a marketplace within a game, according to some examples.

FIG. 5 is a flowchart of a method for authenticating assets, according to some examples.

FIG. 6 is a flowchart of a method for the exchange of assets with direct player transfer, according to some examples.

FIG. 7 is a flowchart of a method for game-asset exchange via third-party deposit, according to some examples.

FIG. 8 is a flowchart of a method for an exchange of assets in the game that includes a real-world asset, according to some examples.

FIG. 9 is a flowchart of a method for integrating a third-party entity in a game to facilitate the exchange of assets within the game, according to some examples.

FIG. 10 is a block diagram illustrating an example of a machine upon or by which one or more example process examples described herein may be implemented or controlled.

### DETAILED DESCRIPTION

Example methods, systems, and computer programs are directed at integrating a third-party entity in a game to facilitate the exchange of assets within the game. Examples merely typify possible variations. Unless explicitly stated otherwise, components and functions are optional and may be combined or subdivided, and operations may vary in sequence or be combined or subdivided. The following description provides numerous specific details to provide a thorough understanding of examples. However, it will be evident to one skilled in the art that the present subject matter may be practiced without these specific details.

Techniques are presented for implementing secure in-game transactions that include user authentication and asset verification. A trusted party, referred to herein as the asset manager (AM), is embedded within the game environment. In some examples, the AM facilitates the exchange of assets, including validating the user, verifying the authenticity of the assets to be exchanged, and controlling the asset transfer.

As used herein, an asset is an item of value or currency owned by an individual, business, or organization. There are digital assets and real-world assets. A digital asset is any content or resource that exists in a digital format and holds value, such as game goods, game currency, digital art, music files, etc. A real-world asset is an asset that may be used in the real world outside the game, such as money, products, or services (e.g., concert tickets).

The AM provides a secure platform for players to exchange assets directly within the game, eliminating the need for external third-party marketplaces.

In one aspect, the AM facilitates the in-game exchange of assets between players. This may include selling a virtual item for money, selling a virtual item for in-game currency, exchanging game assets, etc. The players may exchange assets between themselves, or may also transfer their assets to the AM, and the AM will transfer the assets to the parties to make sure the exchange is balanced. In some examples, a virtual asset to be sold has to be transferred directly to another player, but the AM guarantees that the payment is deposited first. After the seller does a player-to-player (P2P) transfer of the virtual asset, the AM finishes the transaction by submitting the payment to the seller.

In some examples, a player may deposit an asset in a marketplace set up by the AM, and the AM allows other players to buy the asset from the marketplace. If an item sells, the AM transfers the proceeds to the seller.

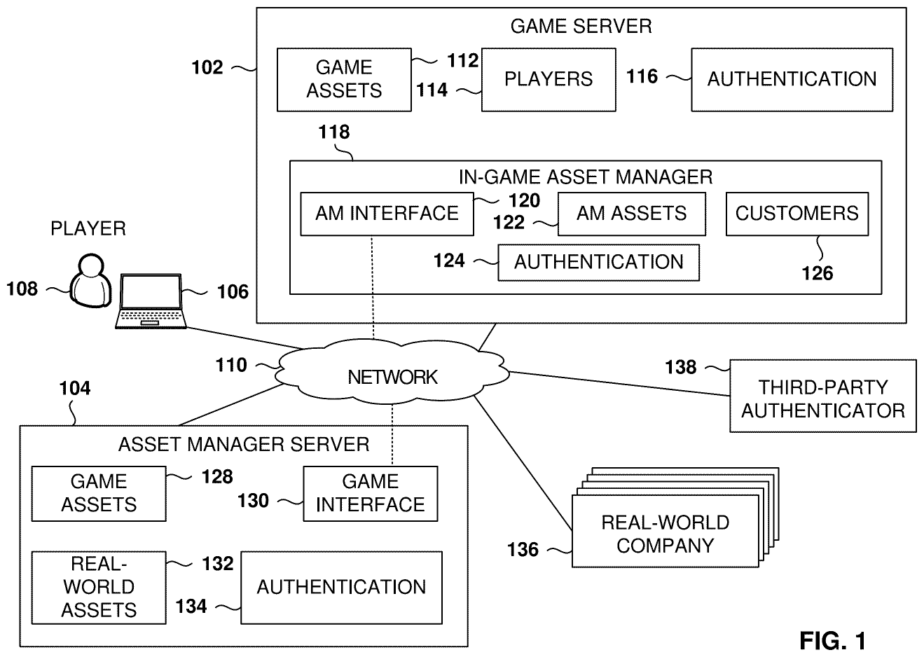

FIG. 1 is a simplified schematic diagram of a computer architecture for implementing the examples described herein. This technology enables the integration of the asset manager in the game to facilitate asset exchanges between users. Although examples are presented for exchanges between two players, the same principles may be used for exchanges that may involve more than two players.

For example, a player in the game (the buyer) wants to buy a game asset (e.g., a custom-designed helmet), and another player who owns the game asset (the seller) wants to sell it for real money. Other examples may include the seller getting a digital asset in exchange, such as in-game currency.

After the players reach an agreement, they can use a trusted third party (the AM) to manage the transaction. The seller may be afraid that if the asset is transferred, the buyer might disappear and never get the money. The buyer may be afraid that if the money is transferred to the seller, the seller may disappear, and the buyer may not get the asset.

There may be other fears, such as the possibility that a digital asset is fake or stolen or the seller is not the rightful owner. The AM facilitates the transaction by validating the assets, verifying the users, and making sure that both parties get their due consideration.

In some examples, the AM integrates into the game, and the game provides a User Interface (UI) where the AM has an avatar that interacts with the avatars of the players to facilitate the transaction. In another example, the players may visit a special location in the game associated with the AM, such as an office, a house, a bank, etc. The presence of the third-party mediator ensures a secure and trustworthy transaction, enhancing the user experience.

The game server 102 is responsible for hosting and managing game-related activities, such as user accounts, logins, and playing the game. The game server 102 includes game assets 112, player database 114, authentication 116, and an in-game asset manager 118. The game assets 112 are digital items or resources used within the game. The player database 114 includes information on user accounts, user profiles, and user progress in the game, including the assets owned by each user. Authentication 116 is a program that verifies the identity of the players.

The in-game asset manager 118 is a program for implementing AM functionality in the game and includes an AM interface 120, AM assets 122, customer data store 126, and authentication 124. The AM interface 120 is the program that manages the communications with an asset manager server 104, and the AM assets 122 is a data store of assets managed by the in-game asset manager 118, such as assets temporarily deposited by players to perform transactions or items put on for sale on a marketplace managed by the in-game asset manager 118. In some cases, the game provides functionality to transfer assets between players, such as from one player to another or from one player to the AM.

The customer data store 126 is a data store of players interacting with the in-game asset manager 118. Further, authentication 124 is the program used to verify the identity of players interacting with the in-game asset manager and the authenticity of assets being exchanged.

A player 108 interacts with the system using a device 106, such as a computer or mobile device, to access game services and assets, AM services, and other entities via a communications network 110.

The asset manager server 104 is a computer server responsible for managing both digital (including game assets) and real-world assets. The asset manager server 104 includes game assets 128, a game interface 130, real-world assets 132, and authentication 134.

The game assets 128 are the digital game assets the AM is supervising, such as resources used within the game, in-game currency, number of lives, etc. The game interface 130 communicates with the AM interface 120 in the game. In some examples, the game provides an Application Programming Interface (API) to integrate the AM within the game.

This integration of the AM within the game enables the gaming platform to display the financial institution as a participant, and the AM can facilitate the transfer of assets and inform players of the assets and the state of the transactions.

Communication between the different entities is encrypted to ensure data security and privacy. The AM stores sensitive information, such as player credentials and transaction data, using secure storage methods to protect against unauthorized access and data breaches. The AM also implements fraud detection algorithms to identify and prevent fraudulent activities, such as monitoring transaction patterns and flagging suspicious behavior for further investigation.

It is noted that although one game server is illustrated, the asset manager server 104 may be used in multiple games and interact with multiple game servers. Further, the real-world assets 132 are the real-world assets managed by the asset manager server 104. Authentication 134 is a program for verifying assets and users.

The introduction of the AM in the game structure enables the secure management of in-game transactions, minimizes fraud, prevents unauthorized transfers, and verifies asset legitimacy to ensure secure transactions.

The game server 102, the player 108, and the asset manager server 104 may also interface with real-world companies 136 that are associated with real-world assets. Further, a third-party authenticator 138 is an external entity responsible for providing additional authentication services that may be utilized by the authentication 124 or the authentication 134.

It is noted that although one server is illustrated for the game server 102 and the asset manager server 104, the implementation may be distributed across a plurality of servers or be implemented using computing and memory resources in a cloud service.

For example, to facilitate transactions within a gaming environment, a player initiates a request to the AM to buy a game asset from a second player using real-world money. After receiving the request, the AM is shown in the game (e.g., an avatar representing the AM) to facilitate the transaction. The AM authenticates the players, verifies the assets for the exchange, collects purchase money, and guarantees that both parties get their part of the bargain.

The AM may access real-world companies 136 to get the money for the transaction or may use the money from an account the player has with the AM. For example, a credit card transaction may be processed to pay for the digital item.

Further, the exchanges are not limited to game assets and may include real-world assets for both players. For example, a player may offer tickets to a concert for sale, and the other player may buy the tickets with real-world money. The AM would transfer the tickets using a real-world company 136 (e.g., Ticketmaster) and transfer the money to the seller, such as by depositing in an account with the AM or with a financial institution like a bank. In some examples, the AM may be part of a financial institution, but the AM may not be associated with a financial institution in other implementations.

The player interactions occur within the game environment, eliminating the need to access external marketplaces. The in-game economy can be utilized alongside existing marketplace integrations, particularly during special events, such as concerts, where the system may serve as a seller or an escrow service.

In some examples, money funds are not moved in and out of the in-game account. Instead, funds are deposited into a settlement account. After the transaction is completed, the funds are cleared from the settlement account.

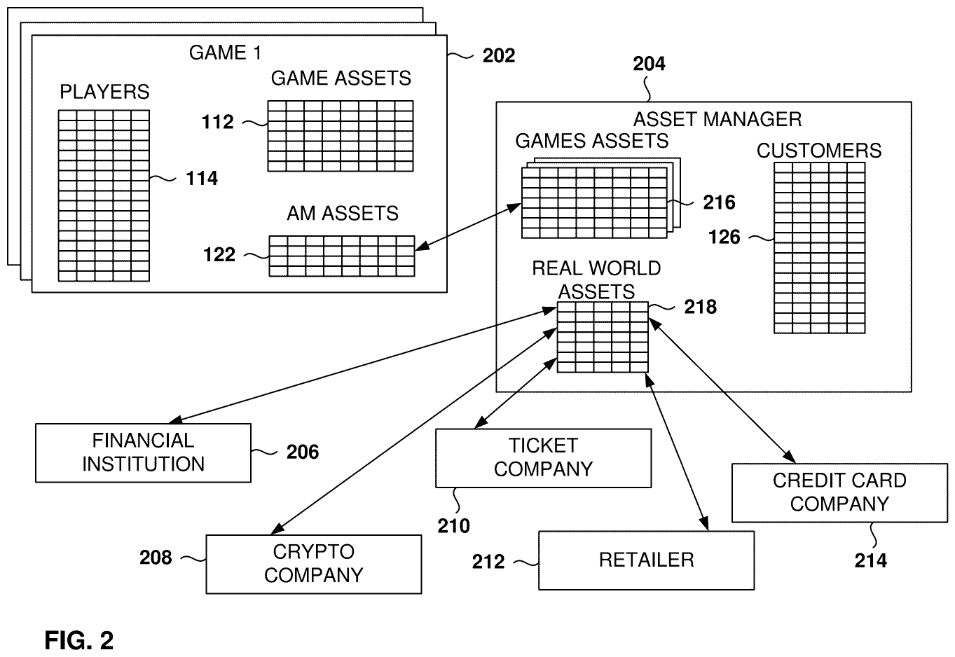

FIG. 2 illustrates a distributed data architecture according to some examples. The architecture includes game data 202, which includes data for the player database 114, game assets 112, and AM assets 122.

The asset manager data 204 comprises data for games assets 216, real-world assets 218, and customer data store 126. The game assets 216 include assets processed by the asset manager from one or more games. In some examples, a separate table is used to store the game assets for each game.

The real-world assets may be of different kinds, such as assets held by a financial institution 206, a crypto company 208, a ticket company 210, a retailer 212, a credit card company 214, etc.

The real-world assets 218 includes information about the real-world asset, such as the company where the real-world asset is deposited, name of the asset, owner of the asset, expiration date, if any, a validation cryptographic key, value of the asset, contact information in the real-world company, account number, etc.

There may be regulations regarding an exchange with a real-world asset, such as transfers to a different country. In this case, the AM will ensure that all pertinent regulations are followed before acting as the intermediary for the transaction.

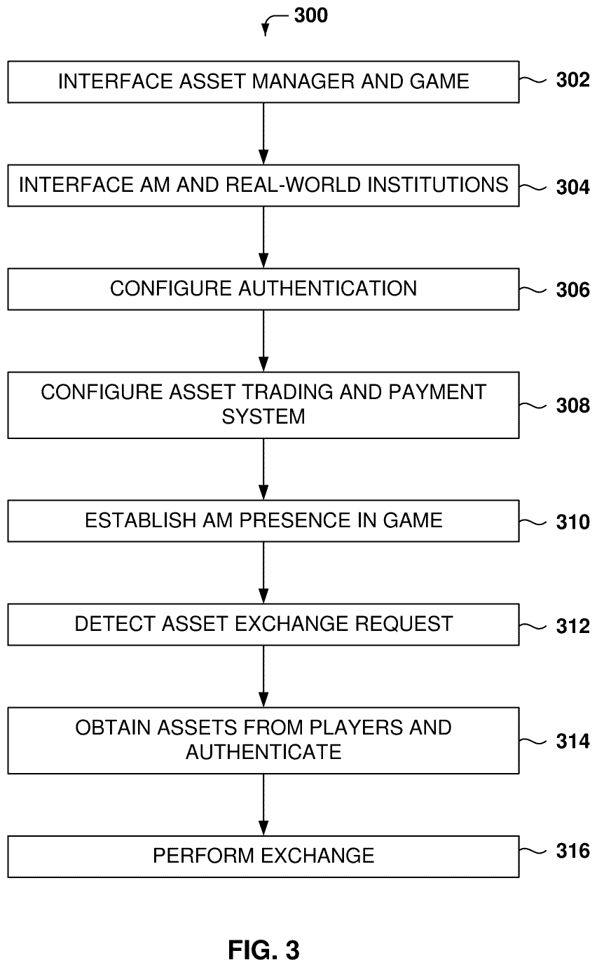

FIG. 3 is a flowchart of a method 300 for the integration of a third party in a game, according to some examples. While the various operations in this flowchart are presented and described sequentially, one of ordinary skill will appreciate that some or all of the operations may be executed in a different order, be combined or omitted, or be executed in parallel.

Operation 302 is for interfacing the asset manager and the game, such as by accessing a game API or an AM API and creating the presence of the AM in the game.

From operation 302, the method 300 flows to operation 304 for interfacing the AM with real-world institutions, such as financial institutions, retailers, ticket sellers, service providers, etc., to enable the AM to facilitate transactions with real-world assets.

From operation 304, the method 300 flows to operation 306 to configure authentication by the AM. Authentication mechanisms are configured to ensure secure interactions between the game, the asset manager, and real-world institutions, such as setting up user authentication protocols (e.g., passwords, biometric verification, two-factor authentication) and asset validation procedures (e.g., a programmatic call to ask the game server to confirm that a certain asset is owned by a player).

From operation 306, the method 300 flows to operation 308 for configuring asset trading and the payment system, which includes setting up the necessary infrastructure to facilitate the buying, selling, and trading of assets from within the game.

From operation 308, the method 300 flows to operation 310 to establish the AM presence in the game, including the integration of the AM's functionalities into the game, and allowing players to interact with the AM directly from within the game. This includes implementing the backend logic to handle account creation requests and store account details in the database.

Further, players can create and link their in-game accounts to the AM for transaction purposes. This can be done through an in-game interface or an external website set up by the AM. Further, the AM may provide an interface for the players so they can view their account details, balance, transaction history, and pending transactions through an interactive in-game menu or an external website.

From operation 310, the method 300 flows to operation 312 for detecting an asset exchange request. The exchange request may arrive via the AM avatar in the game as it interacts with the players in the game.

From operation 312, the method 300 flows to operation 314 for obtaining the assets from the players and authenticating the players and the assets. In some examples, an asset may not be transferred to the AM because the transfer has to be performed directly from one player to another. In this case, the AM will hold the asset (e.g., money) paid by the buyer until there is confirmation that the P2P exchange has taken place.

From operation 314, the method 300 flows to operation 316 for performing the actual exchange of assets, which includes transferring the assets between the players and updating the game and asset manager's records to reflect the transaction.

In some examples, the AM is established to process credit card payments. Further, individuals who hold a credit card backed by the AM may receive additional benefits, like access to commission-free or reduced commission transactions, insurance for the transactions, access to special assets (e.g., participation in a tournament within the game, tickets to a real-world concert), etc. The presence in the game provides a competitive advantage for the credit card processor.

When purchasing an asset, the AM may provide title insurance to ensure that the seller is the actual owner of the asset. This type of insurance can serve as a safeguard for the legitimacy of the asset.

In one example, two real-world assets may be part of the transaction facilitated by the AM. For example, a user may buy an item in an auction.

In some examples, a gift is involved, where a player gifts an item to another player. In some cases, it may not be particularly helpful to involve the AM for in-game transfers because a player may just transfer the asset to the other player, and there is no consideration flowing in the opposite direction.

However, the AM may be useful in cases involving real-world assets or transfers that are not allowed directly by the game platform (e.g., transferring a particular kind of in-game currency to another player). For example, a player may send real-world money to another player, and the money may be deposited in the player's account in a real-world institution after the player withdraws the money from the gifting player.

In an extended scenario, the players may be in different countries, so one player could send money to the other player in the other country. Of course, the AM will enforce all regulations for international transactions. For example, the AM may only transfer funds from a particular country.

In another example, a player may have prepaid accounts with the AM; that is, the player may deposit money in advance that can be used for future transactions. Further, prepaid credit cards may also be configured to be used as a form of payment. Also, in some cases, the AM may provide loan services to players for the purchase of assets.

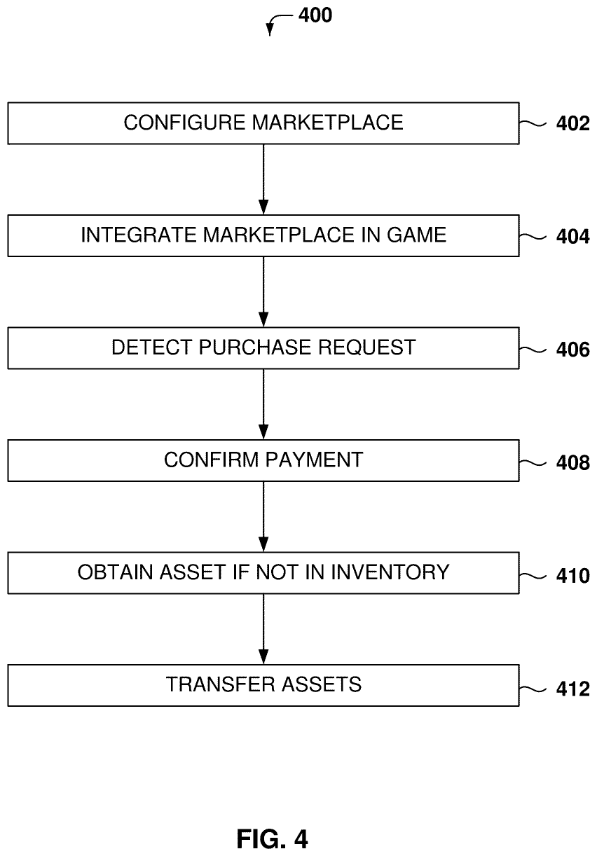

FIG. 4 is a flowchart of a method 400 for implementing a marketplace within a game, according to some examples. While the various operations in this flowchart are presented and described sequentially, one of ordinary skill will appreciate that some or all of the operations may be executed in a different order, be combined or omitted, or be executed in parallel.

In some examples, the AM implements a marketplace in the game. The marketplace may be as simple as a vending machine with game assets, but real-world assets may also be included (e.g., movie tickets). A user interface of a computer game shows a vending machine with multiple items for sale. The player may buy assets (in-game assets or real-game assets) using game currency or real-world currency.

The marketplace may include assets owned by the AM that are available for sale (e.g., a special mask, in-game currency). In some cases, assets that are owned by a player are placed in consignment with the AM, and the seller will get consideration after the item is sold in the marketplace.

A user interface element displays a list of options on the screen, including an option to navigate to the AM marketplace. Upon entering the AM marketplace, items available for purchase are listed. The player can inspect items and select an item (e.g., a sword), complete the payment, and proceed through the established transaction process.

The AM verifies the authenticity of items, such as a virtual sword, and ensures that sellers are in good standing before placing the item for sale. In some cases, revenue is generated by the AM through commissions associated with peer-to-peer transactions. The commission may be any combination of a percentage of the purchase price, a minimum commission, or a flat rate.

Operation 402 is for configuring the marketplace, which involves setting up the marketplace environment, including defining the types of assets available for purchase, pricing models, and any rules or policies governing transactions. A database of items for sale is also initialized.

From operation 402, the method 400 flows to operation 404 for integrating the marketplace in the game. This includes embedding the marketplace interface within the game's user interface and ensuring seamless access for players. The game may implement features to include marketplace access points, such as buttons or menus, and ensure that the marketplace can communicate with the game's core systems to reflect purchases and inventory changes.

From operation 404, the method 400 flows to operation 406 for detecting a purchase request from a player. For example, the player may select an identifier in the vending machine of the item to be purchased and enter a request to buy (e.g., pressing a button on a controller, selecting a buy button with a mouse).

From operation 406, the method 400 flows to operation 408 to confirm payment for the asset. This involves processing the payment through the chosen payment method, which could be in-game currency, real money, or other forms of payment. The computer system would implement this by interfacing with payment gateways or in-game currency systems, ensuring that the payment is successfully processed, and updating the player's balance accordingly.

From operation 408, the method 400 flows to operation 410 for obtaining the asset if it is not in inventory. For example, if the item was placed on consignment, the AM will ensure that the asset is removed from the seller; that is, pass ownership to the AM so that the AM can transfer to the buyer.

From operation 410, the method 400 flows to operation 412 for transferring the assets. This involves doing the corresponding asset transfer from the AM to the buyer and from the AM to the seller. This involves updating the player's inventory or a balance in the account of a real-world institution. Further, the AM may send notifications to the buyer and seller confirming that the transaction was successful.

In one scenario, the marketplace may be implemented as a flea market, where a seller will enter a description of the image and an optional image together with the asking price. A buyer may accept the price or may make an offer to buy the asset for a lesser price.

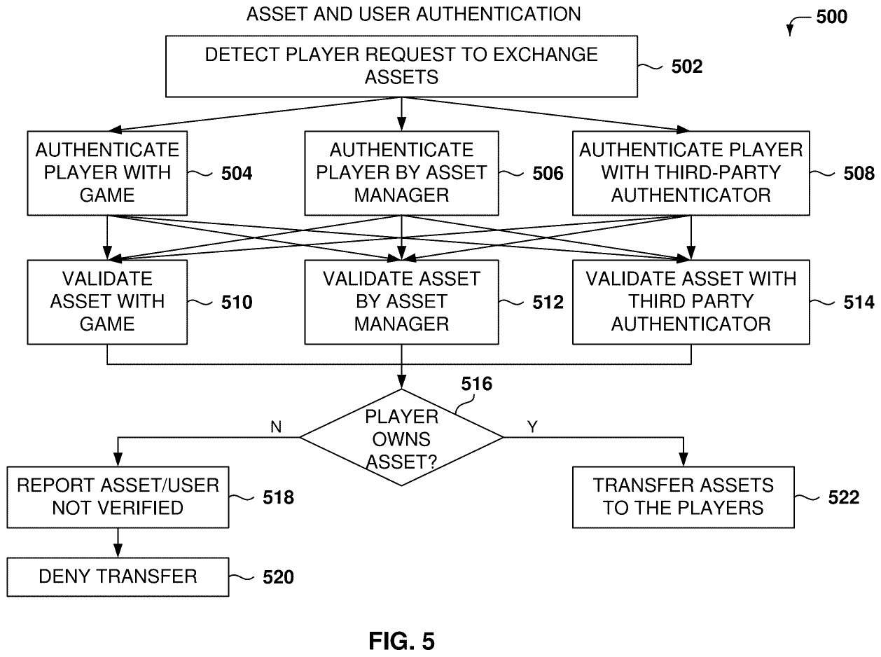

FIG. 5 is a flowchart of a method 500 for authenticating assets, according to some examples. While the various operations in this flowchart are presented and described sequentially, one of ordinary skill will appreciate that some or all of the operations may be executed in a different order, be combined or omitted, or be executed in parallel.

Operation 502 is for detecting a player request to exchange assets. The request may be initiated by the buyer or by the seller, and the other party will confirm the request.

After operation 502, each player is authenticated, and there may be several ways to authenticate the players. One or more authentication methods may be used. Further, the authentication may be different for the buyer and seller. The authentication is performed at operations 504, 506, and 508. Although authentication for one player is described, the other player will be authenticated according to the configuration of the game or the AM.

Operation 504 is for authenticating the player within the game. This involves verifying the player's identity using the game's internal authentication mechanisms. For example, the AM may use the game API to communicate with the game server and authenticate the player. The AM may check the player's credentials, such as username and password, or use other authentication methods to ensure the player is who they claim to be. The AM may use multi-factor authentication, including biometric verification (e.g., facial recognition, fingerprint scanning) and secure passwords, to verify the player's identity.

Further, operation 508 is to the player user with a third-party authenticator, such as an email provider, a financial institution, a government organization, etc. The third-party authenticator provides an additional layer of security by cross-referencing the player's credentials with an independent database or service.

After authenticating the player, the asset of the player is validated, which may also be performed in several ways: by validating the asset with the game, validating the asset by the information stored in the AM, or validating the asset with a third-party authenticator. The validation may be performed in one or more operations selected from operations 510, 512, and 514.

At operation 510, the asset is validated with the game, such as by interacting with the game to determine that the asset is owned by the player. This operation involves checking the asset's status and attributes within the game's database to ensure it is legitimate and eligible for exchange. The AM verifies the asset's ownership, condition, and any other relevant properties.

In some cases, the authentication of the asset may vary based on the value of the asset. Inexpensive assets (e.g., five dollars or less) may not have a stringent validation process, while for expensive assets (e.g., a gold watch, a word of art from a famous artist), the AM will follow more stringent validation methods.

Operation 512 is for validating the asset by the AM, which includes verifying the asset's details against the AM records. The asset manager ensures that the asset is genuine, properly registered, and meets exchange criteria.

Further, operation 514 is for validating the asset with the third-party authenticator. For example, if real-world tickets are being sold, the AM will check with the service that provides the tickets and make sure the player owns the tickets to be sold.

Validating that a digital asset is valid for trade involves ensuring that the asset meets specific criteria, is genuine, and is legally transferable. Some of the ways to validate include the following:
Blockchain verification: Assets like cryptocurrencies or NFTs can be verified by inspecting the asset's transaction history and ownership through the blockchain.
Digital signatures and certificates to check if the asset is signed by a trusted authority. A valid digital signature ensures the asset has not been altered and is authentic. Further, the asset's certificate of authenticity, often issued by a certificate authority (CA) or equivalent entity, may be checked.
Token standards compliance for assets like tokens or NFTs to ensure compliance with relevant standards.
Ownership records may be checked in a public or private ledger. In some cases, the current owner will have to provide proof of ownership, such as a digital certificate or a transaction record, verifying that they have the right to trade the asset.
Asset metadata validation to review the asset's metadata (e.g., descriptions, attributes, etc.) to ensure they match the asset and have not been altered.
Platform and marketplace verification if the asset is listed on a digital marketplace, to ensure the platform has verified the asset. Reputable platforms often have stringent vetting processes. Also, some digital assets can only be traded on certain exchanges. Being listed on a reputable exchange can be a form of validation.
Regulatory compliance to ensure the asset complies with relevant laws and regulations for trade, such as securities regulations, if applicable.
Reputation and trust scores may be checked in some platforms that use reputation or trust scores for players and digital assets, which are based on user feedback, trading history, and other factors.

After the player is validated and the player's asset is authenticated, a check is made to determine if the player owns the asset at operation 516. If the user does not own the asset (N), then the method 500 flows to operation 518, where the players are informed that one or more of the players or one or more of the assets cannot be verified. This operation includes generating a notification or log entry indicating the failure of the authentication or validation process.

From operation 518, the method 900 flows to operation 520, where actions are taken to deny the transfer and return the ownership of the assets to the players as they were before the request was received. The AM prevents the exchange from being executed, ensuring that unauthorized or fraudulent transactions are blocked.

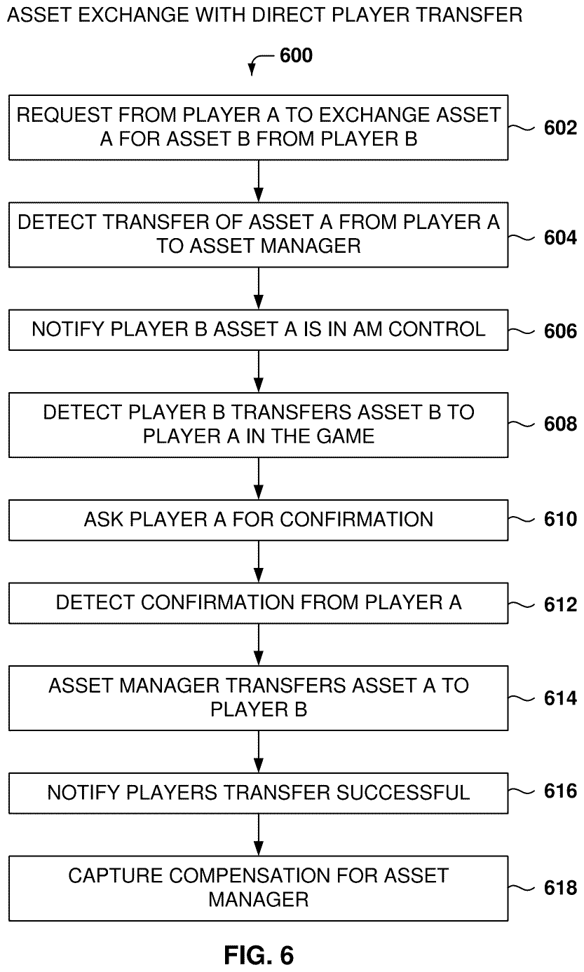

If, at operation 516, a determination is made that both players and both assets are valid, then the method 500 flows to operation 522 to transfer the assets. There may be several ways to exchange the users, depending on whether the assets are deposited first with the AM or if a direct player-to-player transfer is involved. Additionally, the transfer may vary if the transactions include digital or real-world assets. More details are provided below with reference to FIGS. 6-8 to illustrate how different types of transfers are performed.

FIG. 6 is a flowchart of a method 600 for the exchange of assets with direct player transfer, according to some examples. While the various operations in this flowchart are presented and described sequentially, one of ordinary skill will appreciate that some or all of the operations may be executed in a different order, be combined or omitted, or be executed in parallel.

In some examples, a transaction requires that the transaction includes a transfer of a game asset directly from player to player. In many cases, one player sells the game asset (e.g., game currency), and the other player provides money.

Operation 602 is for receiving a request from player A to exchange asset A for asset B from player B. The AM receives the request and oversees the transaction. In this process, the buyer pays the AM, the AM notifies the seller, the seller does a P2P transfer of the game asset, and then the AM gives the money to the seller.

From operation 602, the method 600 flows to operation 604, where the AM detects that player A has transferred asset A to the AM (e.g., money). This detection ensures that Asset A is securely held by the AM before proceeding with the exchange.

From operation 604, the method 600 flows to operation 606 to notify player B that asset A is now with the AM. This notification serves as a confirmation to player B that the asset is ready for exchange.

From operation 606, the method 600 flows to operation 608 for detecting that player B has transferred asset B to player A in the game. This validation may be performed by checking with the game platform or getting a form of receipt showing that the transfer took place.

In some examples, a request is sent to player A to confirm the transfer at operation 610. In other implementations, the confirmation may be obtained differently, such as by checking with the game platform or by being in the game with the two players and witnessing the transfer. This way, there is no problem if player A fails to confirm.

From operation 610, the method 600 flows to operation 612 for detecting the confirmation from player A that validates the exchange.

From operation 612, the method 600 flows to operation 614, where the AM transfers asset A to player B to finish the exchange.

From operation 614, the method 600 flows to operation 616 to notify the players that the transfer was successful.

From operation 616, the method 600 flows to operation 618 for capturing compensation for the AM. For example, the AM may get a commission in real money from a money purchase. In other cases, the AM may get a digital asset as commission, like game currency, typically when the game currency may be exchanged for real money, or the AM has the ability to sell the game currency to other players for money.

In one example scenario, two players engage in gameplay together, with one player possessing a unique sword or acting as a content seller. The players would convene at a virtual location designated as an AM office or an AM bank. This setting would serve as the initial point for verifying the transaction of the item. Both players would join the same server and navigate to the AM location, where a virtual agent would facilitate the process. The seller would present the sword for verification, during which all necessary checks, including blockchain validations, would occur. Upon successful verification, the buyer would transfer the funds, which would also be verified, leading to the completion of the exchange. This model represents a real-world marketplace approach, where both the buyer and seller conduct the transaction in real time at a designated location.

Another example would be for purchasing a unique skin in a Battle Royale Game (e.g., Fortnite). In this scenario, player C wants to buy a unique skin from Player D for $50 within the game. Player C browses the verified player inventory for sale and selects the unique skin listed by Player D. Player C initiates the purchase by selecting an option presented in the UI of “Buy Now.” The AM then prompts Player C to transfer $50 to the AM account within the game. After player C confirms the payment, the $50 is deducted from their in-game wallet and held in the AM account.

The AM then confirms the transaction details with Player D. The AM also verifies the authenticity of the skin using digital signatures and asset provenance tracking. Once the funds are verified, the AM notifies Player D to transfer the unique skin to Player C. Player D initiates the transfer, and the AM tracks the delivery of the skin to Player C's inventory. Player C receives the skin and confirms the receipt and condition of the item through a prompt in the game.

The AM verifies the asset transfer and updates the transaction status. Upon confirmation from Player C, the AM releases the $50 to Player D's in-game wallet. Both players are notified of the successful transaction, and the audit logs are updated.

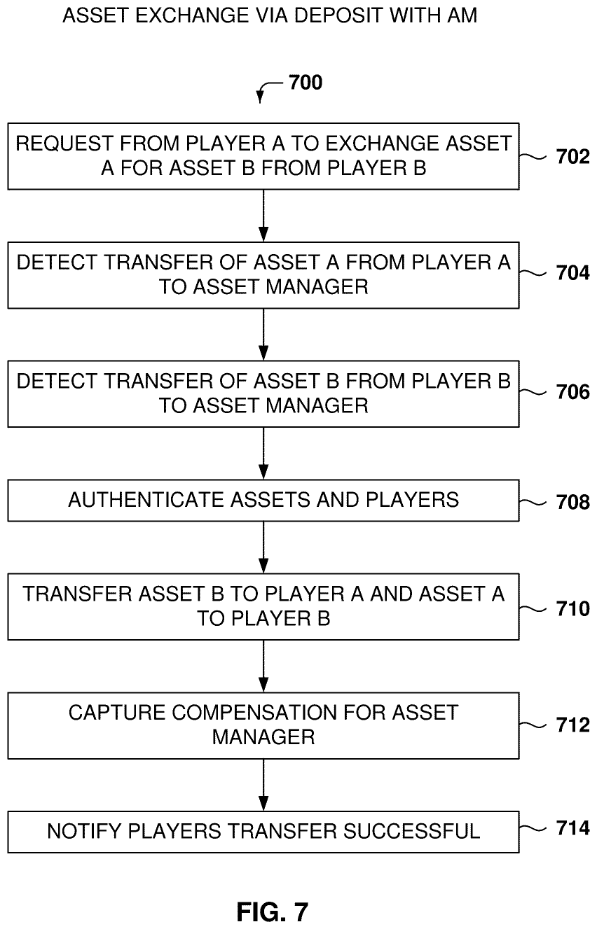

FIG. 7 is a flowchart of a method 700 for game-asset exchange via third-party deposit, according to some examples. While the various operations in this flowchart are presented and described sequentially, one of ordinary skill will appreciate that some or all of the operations may be executed in a different order, be combined or omitted, or be executed in parallel.

In this implementation, both players deposit their assets with the AM. Once the AM has both assets, the AM does the reverse transfer and completes the exchange.

Operation 702 is for detecting, by the AM in the game, a request from player A to exchange asset A for asset B from player B. The request includes details about the assets and the identities of the players.

From operation 702, the method 700 flows to operation 704 for detecting the transfer of asset A from player A to the asset manager. After this transfer, the AM has ownership of asset A (in the game for a digital asset or in the real world for a real-world asset).

From operation 704, the method 700 flows to operation 706 for detecting the transfer of asset B from player B to the asset manager. After this transfer, the AM has ownership of asset B (in the game for a digital asset or in the real world for a real-world asset).

From operation 706, the method 700 flows to operation 708 for authenticating the assets and the players, such as by using the process described with reference to FIG. 5. This includes checking the validity and authenticity of the assets and ensuring they are not counterfeit or otherwise compromised. Additionally, the AM verifies that the players are the legitimate owners of the assets they are attempting to exchange.

If the authentication fails (not shown in the flowchart), the asset exchange is terminated, the players are notified, and the assets are returned.

From operation 708, the method 700 flows to operation 710, where after a successful authentication, the assets are transferred: asset B is transferred to player A, and asset A is transferred to player B. Thus, both players receive the assets they agreed to exchange.

From operation 710, the method 700 flows to operation 712 to capture compensation for the asset manager. This operation is optional for some transfers, as the AM may not capture compensation for reasons such as a promotional offer, a player is a customer of the AM, etc. If the compensation is captured, the compensation may be received from one or both of the players. Further, the compensation may be obtained from the consideration in the exchange. For example, the compensation may be a percentage of an exchange that includes real-world money, and in this case, the seller will receive the price minus the commission. The AM ensures that the compensation is collected before finalizing the exchange.

From operation 712, the method 700 flows to operation 714 for notifying the players that the transfer was completed successfully. The notification can be sent through various communication channels, such as email, in-game messages, or other notification systems.

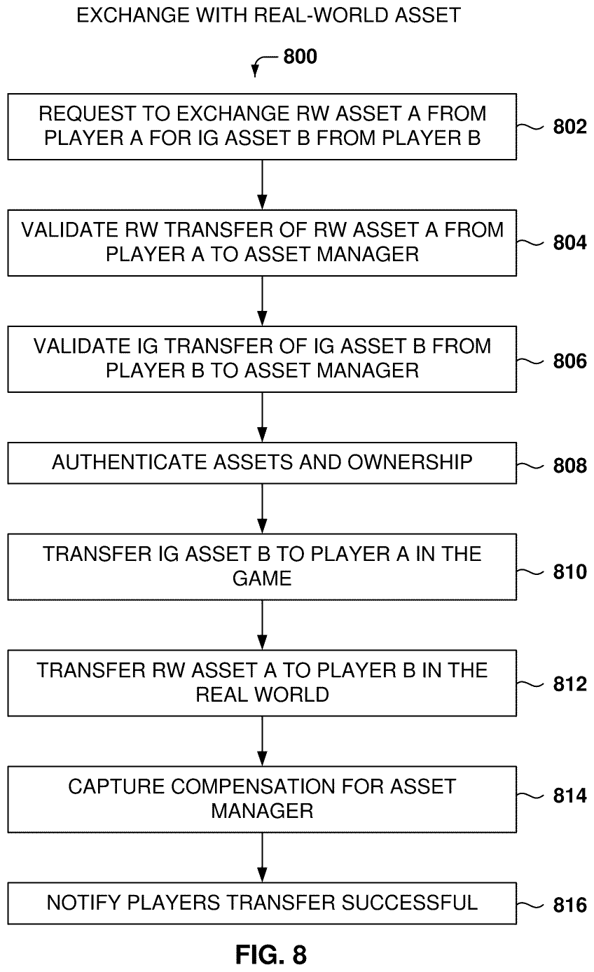

FIG. 8 is a flowchart of a method 800 for an exchange of assets in the game that includes a real-world asset, according to some examples. While the various operations in this flowchart are presented and described sequentially, one of ordinary skill will appreciate that some or all of the operations may be executed in a different order, be combined or omitted, or be executed in parallel.

In this example, one of the assets is a real-world asset, and the other asset is an in-game (IG) asset. The assets are transferred from the players to the AM, but a similar process could also be used with a direct in-game transfer, such as the process illustrated with reference to FIG. 6.

Operation 802 is for detecting, by the AM, a request from player A to exchange a real-world (RW) asset A from player A for an IG asset B from player B.

From operation 802, the method 800 flows to operation 804 for detecting the transfer of RW asset A from player A to the AM. The AM validates the transfer of RW asset A from player A, which includes verifying the authenticity and ownership of the real-world asset to ensure that player A has the right to transfer.

From operation 804, the method 800 flows to operation 806 for detecting the transfer of IG asset B from player B to the AM. The AM validates the transfer of the IG asset B from player B, which includes verifying the authenticity and ownership of the IG asset to ensure that player B has the right to transfer.

From operation 806, the method 800 flows to operation 808 to authenticate the assets and the ownership. If the authentication fails, the exchange is terminated, the assets are returned, and the players are notified.

From operation 808, after a successful authentication, the method 800 flows to operation 810 for transferring the IG asset B to player A in the game.

From operation 810, the method 800 flows to operation 812 for transferring the RW asset A to player B in the real world.

From operation 812, the method 800 flows to operation 814 for capturing compensation for the asset manager. This operation is optional and may not be performed if the AM does not receive a commission.

From operation 814, the method 800 flows to operation 816 for notifying the players that the transfer was successful.

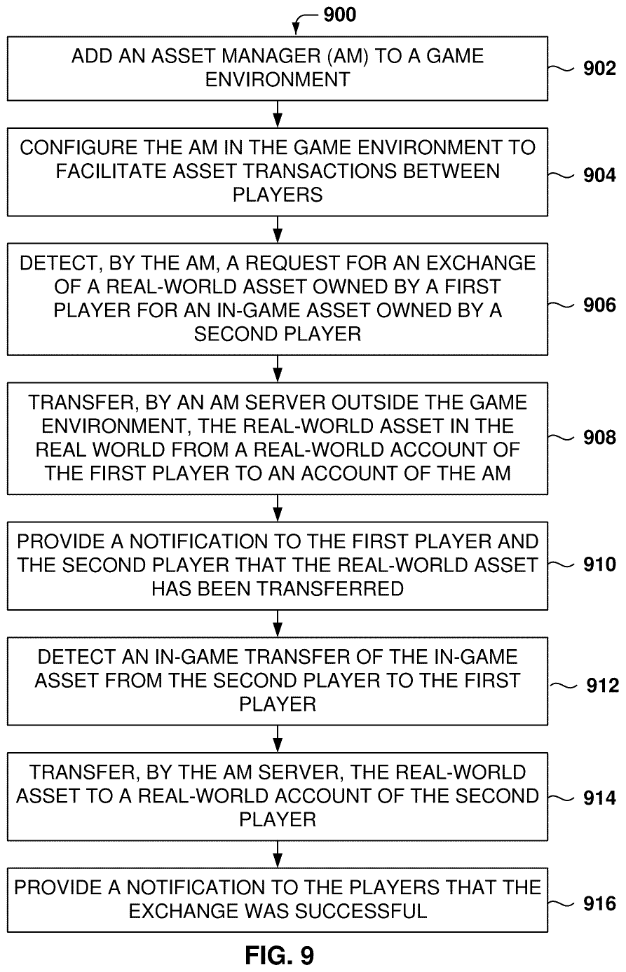

FIG. 9 is a flowchart of a method 900 for integrating a third-party entity in a game to facilitate the exchange of assets within the game, according to some examples. While the various operations in this flowchart are presented and described sequentially, one of ordinary skill will appreciate that some or all of the operations may be executed in a different order, be combined or omitted, or be executed in parallel.

Operation 902 is for adding an asset manager (AM) to a game environment.

From operation 902, the method 900 flows to operation 904 for configuring the AM in the game environment to facilitate asset transactions between players.

From operation 904, the method 900 flows to operation 906 for detecting, by the AM, a request for an exchange of a real-world asset owned by a first player for an in-game asset owned by a second player.

From operation 906, the method 900 flows to operation 908 for transferring, by an AM server outside the game environment, the real-world asset in the real world from a real-world account of the first player to an account of the AM.

From operation 908, the method 900 flows to operation 910 to provide a notification to the first player and the second player that the real-world asset has been transferred.

From operation 910, the method 900 flows to operation 912 for detecting an in-game transfer of the in-game asset from the second player to the first player.

From operation 912, the method 900 flows to operation 914 for transferring, by the AM server, the real-world asset to a real-world account of the second player.

From operation 914, the method 900 flows to operation 916 to provide a notification to the players that the exchange was successful.

In some examples, the method 900 further comprises authenticating the first player and the second player to verify their identity.

In some examples, the first player is authenticated by performing one or more of authenticating the first player within the game environment, authenticating the first player based on data stored by the AM, or authenticating the first player by utilizing a third-party service provider.

In some examples, transferring the real-world asset further comprises validating that the real-world asset is authentic and legally owned by the first player before completing the transfer.

In some examples, adding the AM to the game environment comprises creating an avatar for the AM in the game.

In some examples, adding the AM to the game environment comprises creating an area in the game associated with the AM.

In some examples, transferring the real-world asset further comprises identifying a real-world company holding the real-world asset in the real-world account of the first player, and sending a request to the real-world company to transfer the real-world asset to the account of the AM.

In some examples, adding the AM to the game environment further comprises interfacing the AM server with the game environment via an application programming interface (API) to send requests and receive notifications.

In some examples, the method 900 further comprises sending a request from the AM to a game server to create a marketplace in the game to sell assets within the game to players.

In some examples, the assets for sale in the marketplace are one of assets owned by the AM or assets placed on consignment by players.

Given the disclosure above, various examples are set forth below. It should be noted that one or more features of an example, taken in isolation or combination, should be considered within the disclosure of this application.

Another general aspect is for a system that includes a memory comprising instructions and one or more computer processors. The instructions, when executed by the one or more computer processors, cause the one or more computer processors to perform operations comprising: adding an asset manager (AM) to a game environment; configuring the AM in the game environment to facilitate asset transactions between players; detecting, by the AM, a request for an exchange of a real-world asset owned by a first player for an in-game asset owned by a second player; transferring, by an AM server outside the game environment, the real-world asset from a real-world account of the first player to an account of the AM; providing a notification to the first player and the second player that the real-world asset has been transferred; detecting an in-game transfer of the in-game asset from the second player to the first player; transferring, by the AM server, the real-world asset to a real-world account of the second player; and providing a notification to the players that the exchange was successful.

In yet another general aspect, a tangible machine-readable storage medium (e.g., a non-transitory storage medium) includes instructions that, when executed by a machine, cause the machine to perform operations comprising: adding an asset manager (AM) to a game environment; configuring the AM in the game environment to facilitate asset transactions between players; detecting, by the AM, a request for an exchange of a real-world asset owned by a first player for an in-game asset owned by a second player; transferring, by an AM server outside the game environment, the real-world asset from a real-world account of the first player to an account of the AM; providing a notification to the first player and the second player that the real-world asset has been transferred; detecting an in-game transfer of the in-game asset from the second player to the first player; transferring, by the AM server, the real-world asset to a real-world account of the second player; and providing a notification to the players that the exchange was successful.

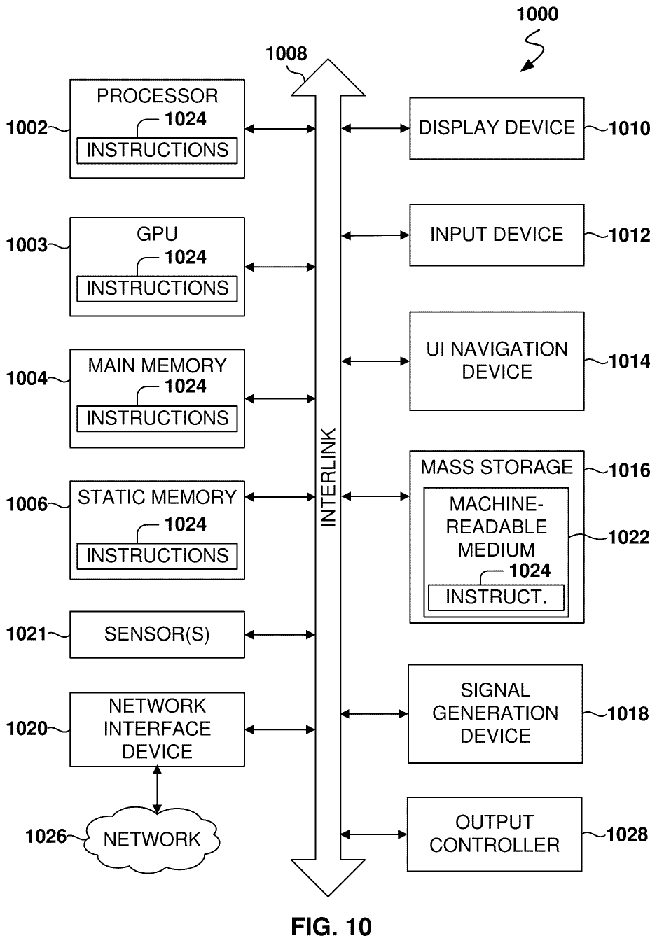

FIG. 10 is a block diagram illustrating an example of a machine 1000 upon or by which one or more example process examples described herein may be implemented or controlled. In alternative examples, the machine 1000 may operate as a standalone device or be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 1000 (e.g., computer system) may include a hardware processor 1002 (e.g., a central processing unit (CPU), a hardware processor core, or any combination thereof), a graphics processing unit (GPU 1003), a main memory 1004, and a static memory 1006, some or all of which may communicate with each other via an interlink 1008 (e.g., bus). The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device 1016 (e.g., drive unit), a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 1002 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 1002 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 1002 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 1002 may be emulated in software, running on a physical processor, as a virtual processor or virtual circuit. The virtual processor may behave like an independent processor but is implemented in software rather than hardware.

The mass storage device 1016 may include a machine-readable medium 1022 on which one or more sets of data structures or instructions 1024 (e.g., software) embodying or utilized by any of the techniques or functions described herein. The instructions 1024 may also reside, completely or at least partially, within the main memory 1004, within the static memory 1006, within the hardware processor 1002, or the GPU 1003 during execution thereof by the machine 1000. For example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium or multiple media (e.g., a centralized or distributed database and associated caches and servers) configured to store one or more instructions 1024.

The term “machine-readable medium” may include any medium that is capable of storing, encoding, or carrying instructions 1024 for execution by the machine 1000 and that causes the machine 1000 to perform any one or more of the techniques of the present disclosure or that is capable of storing, encoding, or carrying data structures used by or associated with such instructions 1024. Non-limiting machine-readable medium examples may include solid-state memories and optical and magnetic media. For example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

What is claimed is:

1. A computer-implemented method comprising:
adding an asset manager (AM) to a game environment;
configuring the AM in the game environment to facilitate asset transactions between players;
detecting, by the AM, a request for an exchange of a real-world asset owned by a first player for an in-game asset owned by a second player;
transferring, by an AM server outside the game environment, the real-world asset from a real-world account of the first player to an account of the AM;
providing a notification to the first player and the second player that the real-world asset has been transferred;
detecting an in-game transfer of the in-game asset from the second player to the first player;
transferring, by the AM server, the real-world asset to a real-world account of the second player; and
providing a notification to the players that the exchange was successful.

2. The method as recited in claim 1, further comprising:
authenticating the first player and the second player to verify their identity.

3. The method as recited in claim 2, wherein the first player is authenticated by performing one or more of authenticating the first player within the game environment, authenticating the first player based on data stored by the AM, or authenticating the first player by utilizing a third-party service provider.

4. The method as recited in claim 1, wherein transferring the real-world asset further comprises:
validating that the real-world asset is authentic and legally owned by the first player before completing the transfer.

5. The method as recited in claim 1, wherein adding the AM to the game environment comprises creating an avatar for the AM in the game.

6. The method as recited in claim 1, wherein adding the AM to the game environment comprises creating an area in the game associated with the AM.

7. The method as recited in claim 1, wherein transferring the real-world asset further comprises:
identifying a real-world company holding the real-world asset in the real-world account of the first player; and
sending a request to the real-world company to transfer the real-world asset to the account of the AM.

8. The method as recited in claim 1, wherein adding the AM to the game environment further comprises:
interfacing the AM server with the game environment via an application programming interface (API) to send requests and receive notifications.

9. The method as recited in claim 1, further comprising:
sending a request from the AM to a game server to create a marketplace in the game to sell assets within the game to players.

10. The method as recited in claim 9, wherein the assets for sale in the marketplace are one of assets owned by the AM or assets placed on consignment by players.

11. A system comprising:
a memory comprising instructions; and
one or more computer processors, wherein the instructions, when executed by the one or more computer processors, cause the system to perform operations comprising:
adding an asset manager (AM) to a game environment;
configuring the AM in the game environment to facilitate asset transactions between players;
detecting, by the AM, a request for an exchange of a real-world asset owned by a first player for an in-game asset owned by a second player;
transferring, by an AM server outside the game environment, the real-world asset from a real-world account of the first player to an account of the AM;
providing a notification to the first player and the second player that the real-world asset has been transferred;
detecting an in-game transfer of the in-game asset from the second player to the first player;
transferring, by the AM server, the real-world asset to a real-world account of the second player; and
providing a notification to the players that the exchange was successful.

12. The system as recited in claim 11, wherein the instructions further cause the one or more computer processors to perform operations comprising:
authenticating the first player and the second player to verify their identity.

13. The system as recited in claim 12, wherein the first player is authenticated by performing one or more of authenticating the first player within the game environment, authenticating the first player based on data stored by the AM, or authenticating the first player by utilizing a third-party service provider.

14. The system as recited in claim 11, wherein the instructions further cause the one or more computer processors to perform operations comprising:
validating that the real-world asset is authentic and legally owned by the first player.

15. The system as recited in claim 11, wherein adding the AM to the game environment comprises creating an avatar for the AM in the game.

16. A non-transitory machine-readable storage medium including instructions that, when executed by a machine, cause the machine to perform operations comprising:
adding an asset manager (AM) to a game environment;
configuring the AM in the game environment to facilitate asset transactions between players;
detecting, by the AM, a request for an exchange of a real-world asset owned by a first player for an in-game asset owned by a second player;
transferring, by an AM server outside the game environment, the real-world asset from a real-world account of the first player to an account of the AM;
providing a notification to the first player and the second player that the real-world asset has been transferred;
detecting an in-game transfer of the in-game asset from the second player to the first player;
transferring, by the AM server, the real-world asset to a real-world account of the second player; and
providing a notification to the players that the exchange was successful.

17. The non-transitory machine-readable storage medium as recited in claim 16, wherein the machine further performs operations comprising:
authenticating the first player and the second player to verify their identity.

18. The non-transitory machine-readable storage medium as recited in claim 17, wherein the first player is authenticated by performing one or more of authenticating the first player within the game environment, authenticating the first player based on data stored by the AM, or authenticating the first player by utilizing a third-party service provider.

19. The non-transitory machine-readable storage medium as recited in claim 16, wherein the machine further performs operations comprising:
validating that the real-world asset is authentic and legally owned by the first player.

20. The non-transitory machine-readable storage medium as recited in claim 16, wherein adding the AM to the game environment comprises creating an avatar for the AM in the game.
